(19) United States
(12) Patent Application Publication
(10) Pub. No.: US 2014/0303753 A1
(43) Pub. Date: Oct. 9, 2014

(54) Anti-hacking system for PLC

(71) Applicant: Behrouz Golabil, Scottsdale, AZ (US)

(72) Inventor: Behrouz Golabil, Scottsdale, AZ (US)

(73) Assignee: J & K Management Inc

(21) Appl. No.: 13/986,135

(22) Filed: Apr. 4, 2013

(51) Int. Cl. G05B 15/02

(52) U.S. Cl. CPC G05B 15/02
USPC 700/79

(57) ABSTRACT

The invention provides a control system which is resistant to external interference such as hacking. The control system receives sensor data from a remote sensor indicating a physical condition such as temperature, flow rate, or internal pressure, and provides operational data to a remote operational mechanism such as those found in a variety of production and manufacturing environments which is adapted to influence the physical condition. The system employs a memory unit which contains a data set establishing range of operational values for the operating mechanism. A programmable logic circuit accesses the data set and the sensor data, allowing the programmable logic circuit to generate the operational data for the remote operational mechanism. To maintain the data in pristine state, a programmable unit periodically accesses the memory unit to verifying that the range of operational values within the data set is within a prescribed range and adjusts the data set to comply with the prescribed range.

### BACKGROUND OF THE INVENTION

This invention relates generally to Programmable Logic Circuits (PLCs) and more particularly a system adapted to thwart hacking attempts.

Security is a major concern for all manners of digital controls. Some such attempts for security are described in: U.S. Pat. No, 8,132,225, entitled “Scalable and Flexible Information Security for Industrial Automation” issued to Chand et al. on Mar. 6, 2012; and, U.S. Pat. No. 8,132,049, entitled “Failure Diagnosis Method, Failure Diagnosis Apparatus, Conveyance Device, Image Forming Apparatus, Program, and Storage Medium” issued to Yasukawa et al. on Mar. 6, 2012; both of which are incorporated hereinto by reference.

Programmable Logic Circuits are employed in a wide variety of applications due to their simplicity of operation and programming ease. Unfortunately, because of these very attributes, they also are easily “hacked” allowing an interloper to cause serious results. Because of the use of PLC's in so many applications (e.g. traffic signal controls, hydrocarbon refining, municipal water systems, train control mechanisms, etc.), a simple alteration of the operation or scope of operation can cause catastrophic affects.

To make matters even worse, almost all of these PLC systems have little or no security associated with them. This makes the systems “soft targets” for terrorists as there is little or no risk to the terrorist while there is the potential for extended detrimental affects.

It is clear there is a need for additional security for PLC mechanisms.

### SUMMARY OF THE INVENTION

The invention provides a control system which is resistant to external interference such as hacking and terrorism.

The invention creates a monitoring system for the data base used to control the range of operations for the system. The programmable monitor periodically checks the data base to make sure that it is within the prescribed limits; if it is not, then a hacker may have entered the system and maliciously adjusted the values in an attempt to cause the shut down or destruction of the system being controlled. The monitor “resets” the data base to contain the prescribed range and then continues to monitor the system.

In more detail, the control system receives sensor data from a remote sensor showing a physical condition being monitored and provides operational data to a remote operational mechanism which affects the physical condition being monitored. These systems are often referred to as “Programmable Logic Controllers” (PLC) systems in which the PLC monitors the operation of a remote mechanism via a sensor placed there.

Those of ordinary skill in the art readily recognize a variety of component system which can be used in this context, including, but not limited to: U.S. Pat. No. 8,131,897, entitled “Semiconductor Memory Device Inputting and Outputting a Plurality of Data Length Formats and Method Thereof” issued to Kim et al. on Mar. 6, 2012; U.S. Pat. No. 8,131,827, entitled “PLC with Web-Accessible Program Development Software” issued to Batke et al. on Mar. 6, 2012; U.S. Pat. No. 8,131,396, entitled “Numerical Control Apparatus and Numerical Control System” issued to Yamada on Mar. 6, 2012; U.S. Pat. No. 8,130,672, entitled “Method of Multicasting and Transmitting Data in PLC Network and an Apparatus Thereof” issued to Lee et al. on Mar. 6, 2012; U.S. Pat. No. 8,031,758 entitled “Powerline Communciation (PLC) Modem Employing an Analog Electromagnetic Transducer” issued to Dawson et al. on Oct. 4, 2011; and, U.S. Pat. No. 7,941,239, entitled “PLC” issued to Ikegami et al. on May 10, 2011; all of which are incorporated hereinto by reference.

To define the range of operation, a memory unit is used. The memory unit contains a data set establishing range of operational values for the operating mechanism; the programmable logic circuit accesses the data set and the sensor data, allowing the programmable logic circuit to generate the operational data for the remote operational mechanism. As example, the measuring unit's data set may establish the optimal temperature range for the oil being refined as being between 100 and 150 degrees Celsius.

The invention utilizes a variety of components such as those described in: U.S. Pat. No. 8,132,071, entitled “Transmitting Device, Receiving Device, Packet Transmission Method, Packet Reception Method, and Programs for Same” issued to Hayashi on Mar. 6, 2012; U.S. Pat. No. 8,131,443, entitled “Acceleration Control System” issued to Inou et al. on Mar. 6, 2012; and, U.S. Pat. No. 8,131,153, entitled “Power Line Communication System Using Hybrid-Fiber Coaxial and Communication Device Used in the System” issued to Park et al. on Mar. 6, 2012; all of which are incorporated hereinto by reference.

To maintain the data in pristine state, a programmable unit, separate from the PLC, periodically accesses the memory unit to verifying that the range of operational values within the data set is within a prescribed range and adjusts the data set to comply with the prescribed range. These values within the memory are vulnerable to hackers and can be easily modified to ranges which can be detrimental to the operation of the mechanism.

A programmable unit is employed that uses its own non-volatile memory as a template for the ranges of values. Using the template, the programmable unit determines if the memory employed by the PLC has been corrupted (either through a hacker or malfunction) and resets the value within the PLC memory to the proper values if needed.

In this way, the programmable unit maintains the ranges and if the values continue to waiver after correction, an alarm or notice can be given to an operator so that remedial action can be taken, either by the operator or automatically such as shut down of the mechanism to avoid a catastrophic reaction.

The invention, together with various embodiments thereof will be more fully explained by the accompanying drawings and the following descriptions thereof.

### DRAWINGS IN BRIEF

FIG. 1 is a block diagram of the control assembly interacting with a production facility.

FIG. 2 is a diagram of the preferred control assembly of the invention.

FIG. 3 is a flow chart of the operation of the programmable unit monitoring the parameters used by the PLC.

FIG. 4 is a flow chart of the operation of the remote computer establishing the parameters within the memory of the programmable unit.

### DRAWINGS IN DETAIL

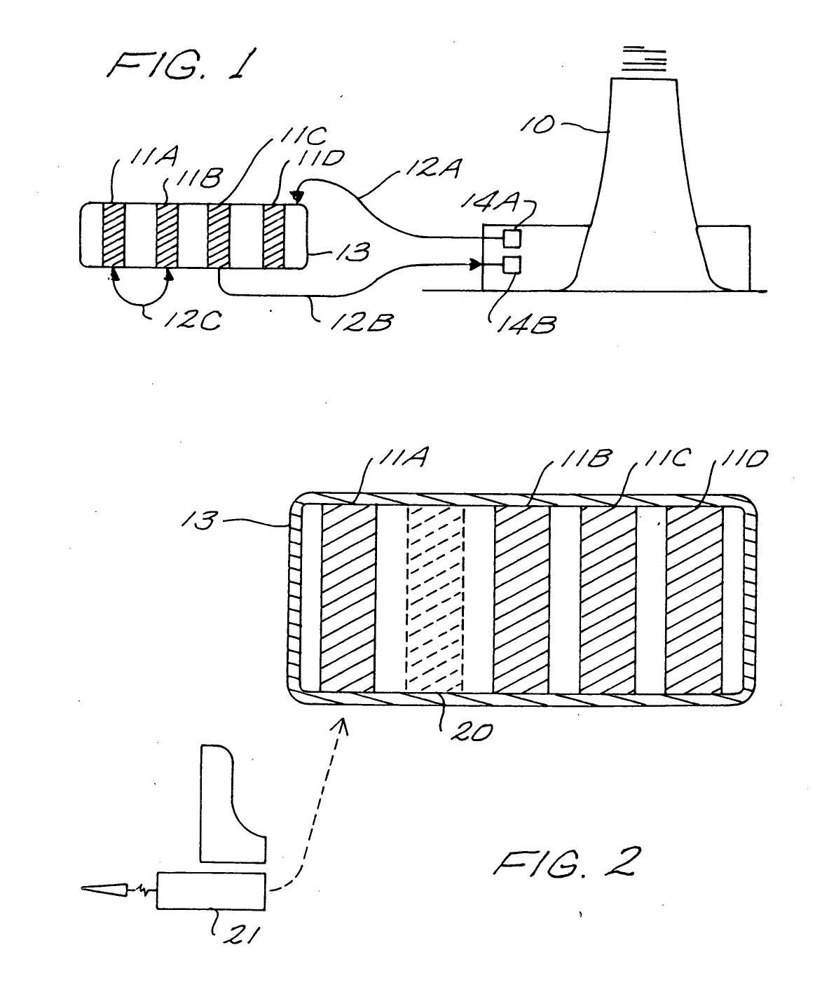

FIG. 1 is a block diagram of the control assembly interacting with a production facility. Production facility 10 performs a series of procedures on a raw material to generate a final product. As noted, this final product may be petroleum based, a light bulb, or any other sort of manufactured product.

A remote sensor 14A within production facility 10 generates a signal 12A indicative of a physical condition of a manufacturing step within the production activity. As example, signal 12A may indicate the temperature of the oil as it is being processed.

Signal 12A is communicated to control assembly 13 which employs an input module 11D. Input module 11D is adapted to receive signal 12A and structure it properly for PLC 11B to recognize the signal.

PLC 11B, in using the signal from input module 11D, ascertains if the signal falls within a prescribed range as previously established. If the signal is outside of the prescribed range, then PLC 11B sends a signal 12B via output module 11C to a remote operational mechanism 14B within the production facility 10. Signal 12B controls the remote operational mechanism 14B to, as in the oil example, increase the heat being applied to the oil.

Programmable unit 11A, within the control assembly 13, periodically monitors (12C) the memory associated with PLC 11B to make sure that the parameters within the memory for ideal operation of production facility 10 do not vary from the prescribed values. Programmable unit 11A utilizes its own memory which are not remotely accessible. This memory acts as a template for the parameters within PLC 11B.

If the values do wander, then programmable unit 11A via signal 12C adjusts the memory of PLC 11B to again reflect the optimal operating values.

In this manner, an external hacker or an internal problem with PLC 11B, may be able to temporarily alter the optimal parameters, but, this error is quickly identified and corrected.

FIG. 2 is a diagram of the preferred control assembly of the invention.

Control assembly 13 is a typical rack for holding the various units to control operation with the production facility (shown in FIG. 1). Within control assembly 13 is the programmable unit 11A, the PLC 11B (which performs the analysis and control operation), output module 11C, and input module 11D. An optional memory 20 is also added in some embodiments to hold the operational parameters used by the PLC 11B and monitored by programmable unit 11A.

While PLC 11B may be remotely accessible, programmable unit 11A is not. Ideally, programmable unit 11A can only be modified by a hardwire connection to computer 21. This requirement keeps the memory within programmable unit 11A from being tampered with from remote sources.

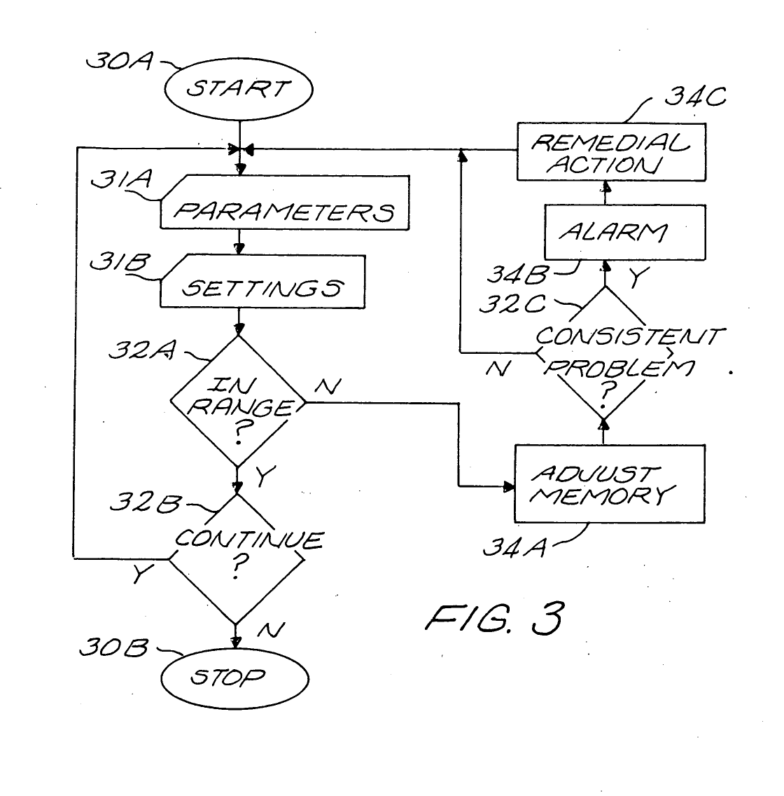

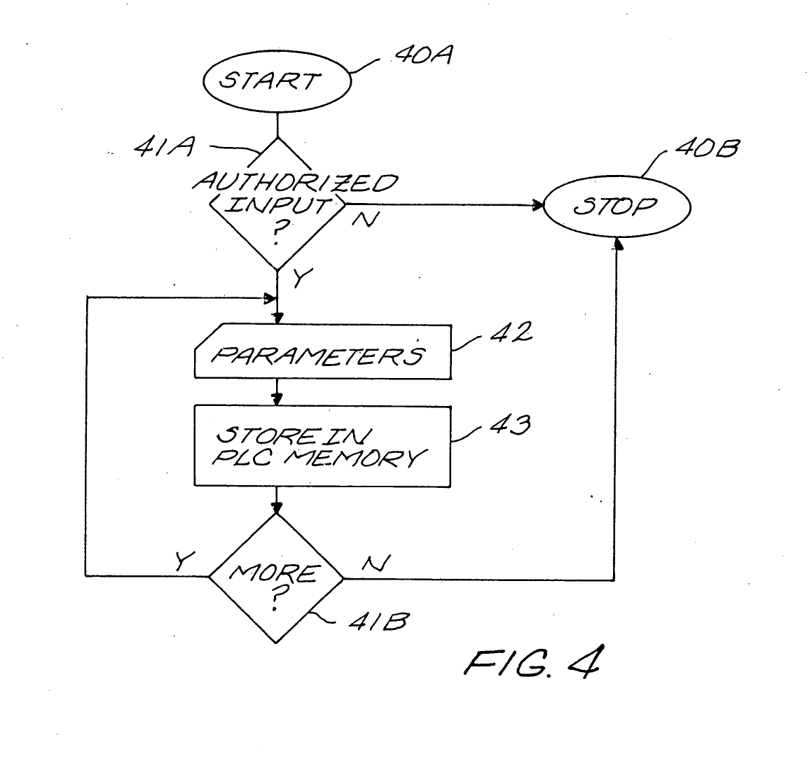

FIG. 3 is a flow chart of the operation of the programmable unit monitoring the parameters used by the PLC.

Once the program starts 30A, the parameters 31A being used by the PLC are collected from the memory used by the PLC (either internal to the PLC or a stand-alone memory module). The proper settings 31B are obtained from the memory accessible only by the programmable unit. The parameters and settings are compared and a determination on if they coincide is made 32A. If they do (Y), then the decision is made to continue operation 32B (typically an interrupt is provided to terminate operation) and if the operation is not to continue (N) then the program stops 30B; otherwise, the program returns and pulls the parameters 31A again.

If the parameters and settings are not consistent 32A (N), then the memory of the PLC is adjusted 34A. A determination is made if the problem seems to be consistent or re-occurring 32C. If the problem is consistent 32C (Y), then an alarm is given to the operator 34B and remedial action is taken 34C. The program then continues back to repeat the process.

If the problem is not consistent 32C (N), then the program continues back to repeat the cycle. In this manner, the programmable unit maintains survailance of the PLC memory values and assures that the values are in the proper condition.

FIG. 4 is a flow chart of the operation of the remote computer establishing the parameters within the memory of the programmable unit.

Once the program starts 40A, a determination is made on if the input is authorized 41A. This is done by entry of a security code or the use of removable memory unit which contains an authorization code.

If the entry is not authorized (N), then the program stops 40B; if the input is authorized (Y), then the parameters 42 are read and then stored into the PLC memory 43. A check on if there are more parameters to store 418 is made. If there are more parameters (Y) then the program cycles back to collect and store the parameters as indicated above; if no more parameters are to be stored (N), then the program stops 40B.

In this manner, the hardwired connection between the computer and the programmable unit as outlined in FIG. 2 permits the parameters to be used by the PLC to be entered and stored.

It is clear that the present invention provides for a greatly enhanced security system for PLC operating systems.

What is claimed is:

1. A control system comprising:
a) a remote sensor generating sensor data indicative of a physical condition;
b) a remote operational mechanism being responsive to operational data;
c) a memory unit containing a data set establishing a range of operational values;
d) a programmable logic circuit accessing said data set and said sensor data, said programmable logic circuit generating the operational data for said remote operational mechanism in response to said data set and the sensor; and,
e) a programmable unit accessing said memory unit, said programmable unit periodically verifying that the range of operational values within the data set is within a prescribed range and adjusting said data set to comply with the prescribed range.

2. The control system according to claim 1, wherein said memory unit is resident within the programmable logic circuit.

3. The control system according to claim 1, wherein said memory unit is separate from the programmable logic circuit and the programmable unit.

4. The control system according to claim 1, wherein said programmable unit further includes a capability to:
a) confirm that after adjustment of said data set, said data set remains within the prescribed range; and,
b) If the adjusted data set does not remain within the prescribed range, said programmable unit takes remedial action.

5. The control system according to claim 4,
a) further including an operator interface; and,
b) wherein said remedial action includes notifying an operator.

6. The control system according to claim 4,
a) wherein said programmable logic circuit includes a capability to shut down said remote operational mechanism; and,
b) wherein said remedial action by said programmable unit includes directing said programmable logic circuit to perform a shutdown of said remote mechanism.

7. The control system according to claim 2, wherein said programmable unit includes an input port accepting programming from a remote computer.

8. The control system according to claim 7, wherein said input port on said programmable unit can only accept programming when physically connected to said remote computer.

9. A control system receiving sensor data from a remote sensor monitoring a physical condition and providing operational data to a remote operational mechanism adapted to affect the physical condition, said control system comprising:
a) a memory unit containing a data set establishing range of operational values;
b) a programmable logic circuit accessing said data set and the sensor data, said programmable logic circuit generating the operational data for said remote operational mechanism in response to said data set and the sensor data; and,
c) a programmable unit accessing said memory unit, said programmable unit periodically verifying that the range of operational values within the data set is within a prescribed range and adjusting said data set to comply with the prescribed range.

10. The control system according to claim 9, wherein said memory unit is resident within the programmable logic circuit.

11. The control system according to claim 9, wherein said memory unit is separate from the programmable logic circuit and the programmable unit.

12. The control system according to claim 9, wherein said programmable unit further includes a capability to:
a) confirm that after adjustment of said data set, said data set remains within the prescribed range; and,
b) If the adjusted data set does not remain within the prescribed range, said programmable unit takes remedial action.

13. The control system according to claim 12,
a) further including an operator interface; and,
b) wherein said remedial action includes notifying an operator.

14. The control system according to claim 12,
a) wherein said programmable logic circuit includes a capability to shut down said remote operational mechanism; and,
b) wherein said remedial action by said programmable unit includes directing said programmable logic circuit to perform a shutdown of said remote mechanism.

15. The control system according to claim 10, wherein said programmable unit includes an input port accepting programming from a remote computer.

16. The control system according to claim 15, wherein said input port on said programmable unit can only accept programming when physically connected to said remote computer.

17. A control system receiving sensor data from a remote sensor being indicative of a physical condition and providing operational data to a remote operational mechanism, said control system housed in a single container and comprising:
a) a memory unit containing a data set establishing range of operational values;
b) a programmable logic circuit accessing said data set and the sensor data, said programmable logic circuit generating the operational data for said remote operational mechanism in response to said data set and the sensor data; and,
c) a programmable unit accessing said memory unit, said programmable unit periodically verifying that the range of operational values within the data set is within a prescribed range and adjusting said data set to comply with the prescribed range.

18. The control system according to claim 17, wherein said programmable unit further includes a capability to:
a) confirm that after adjustment of said data set, said data set remains within the prescribed range; and,
b) If the adjusted data set does not remain within the prescribed range, said programmable unit takes remedial action.

19. The control system according to claim 18,
a) further including an interface accessible on an exterior of said housing; and,
b) wherein said programmable unit can only accept programming via said interface.
